(19) United States
(12) Patent Application Publication
(10) Pub. No.: US 2020/0223241 A1
(43) Pub. Date: Jul. 16, 2020

(54) INFORMATION PROCESSING DEVICE, ALTERNATIVE SETTING METHOD OF INFORMATION PROCESSING DEVICE, AND PROGRAM

(71) Applicant: Seiko Epson Corporation, Tokyo (JP)

(72) Inventor: Mitsuhiro YAMASHITA, Suwa-shi (JP)

(73) Assignee: Seiko Epson Corporation, Tokyo (JP)

(21) Appl. No.: 15/751,750

(22) PCT Filed: Jul. 15, 2016
(86) PCT No.: PCT/JP2016/071090

§ 371 Date: Feb. 9, 2018

(30) Foreign Application Priority Data
Aug. 11, 2015 (JP) 2015-158947

(51) Int. Cl. B41J 29/38; G06F 3/12

(52) U.S. Cl. CPC B41J 29/38; G06F 3/1255; G06F 3/1292; G06F 3/1208; G06F 3/1243

(57) ABSTRACT

An information processing device includes: a width dimension acquisition section that acquires a width dimension of a tape on which a character image is to be printed; and an alternative setting section that sets a maximum alternative, which represents a selectable alternative having a maximum size among a plurality of alternatives for selecting a point size of the character image, according to the acquired width dimension so that the character image does not protrude from the tape.

### TECHNICAL FIELD

The present invention relates to an information processing device, an alternative setting method of the information processing device, and a program.

### BACKGROUND ART

Conventionally, there has been known a label printing apparatus that determines a printing area of a label based on label information and sets a maximum character size falling within the printing area as an initial value of a character size. The label printing apparatus finally sets a maximum character size, at which a character is capable of being printed in a printing area, by automatically updating the character size according to a character number and a line number of an input character string (see Patent Document 1).
[Patent Document 1] JP-A-6-024086

The present inventor has found the following problem.

When a character image to be printed on a tape is automatically set to have a maximum size falling within a width dimension of the tape like a conventional label printing apparatus in an information processing device, a user is not allowed to select a size of the character image.

The present invention has an object of providing an information processing device, an alternative setting method of the information processing device, and a program that allow a user to select a size of a character image within a range in which the character image does not protrude from a tape.

### DISCLOSURE OF THE INVENTION

An information processing device according to the present invention includes: a width dimension acquisition section that acquires a width dimension of a tape on which a character image is to be printed; and an alternative setting section that sets a maximum alternative, which represents a selectable alternative having a maximum size among a plurality of alternatives for selecting a size of the character image, according to the acquired width dimension so that the character image does not protrude from the tape.

An alternative setting method of an information processing device according to the present invention performs: a step of acquiring a width dimension of a tape on which a character image is to be printed; and a step of changing a selectable alternative having a maximum size among a plurality of alternatives for selecting a size of the character image according to the acquired width dimension so that the character image does not protrude from the tape.

A program according to the present invention causes a computer to function as the respective sections of the above information processing device.

According to the configuration, a character image is printed so as not to protrude from a tape even when a maximum alternative is selected. Thus, according to the configuration, a user is allowed to select a size of a character image within a range in which the character image does not protrude from a tape.

In the information processing device, the alternative setting section preferably determines an upper limit size of the character image, at which the character image does not protrude from the tape, based on the acquired width dimension, and the alternative setting section preferably sets an alternative having a maximum size that does not exceed the determined upper limit size among the plurality of alternatives as the maximum alternative.

According to the configuration, an alternative closer to an upper limit size of a character image is set as a maximum alternative. Thus, according to the configuration, a maximum alternative within a range in which a character image does not protrude from a tape can be set as a maximum alternative.

In this case, the information processing device preferably further includes: a length and width conversion section that changes a direction of the character image that is to be printed on the tape between a horizontal writing direction in which a vertical direction of the character image is parallel to a width direction of the tape and a vertical writing direction in which the vertical direction of the character image is parallel to a length direction of the tape. The alternative setting section preferably sets the maximum alternative based on a vertical dimension of the character image in the horizontal writing direction in both a case in which the character image is oriented in the horizontal writing direction and a case in which the character image is oriented in the vertical writing direction.

According to the configuration, a change in a maximum alternative is prevented when a direction of a character image is changed between the horizontal writing direction and the vertical writing direction.

In this case, the information processing device preferably further includes: a line number setting section that sets a print line number in the width direction of the tape. The alternative setting section preferably sets the maximum alternative based on the set print line number.

According to the configuration, a maximum alternative is changed according to a print line number.

In this case, the information processing device preferably further includes: a size setting section that sets the size of the character image. When the size of the character image set before an increase in the print line number exceeds the maximum alternative set after the increase in the print line number, the size setting section preferably sets the size of the character image after the increase in the print line number so as not to exceed the maximum alternative set after the increase in the print line number.

According to the configuration, when a size of a character image set before an increase in a print line number exceeds a maximum alternative set after the increase in the print line number, the size of the character image after the increase in the print line number is automatically set so that the character image does not protrude from a tape.

In this case, when the size of the character image set before the increase in the print line number does not exceed the maximum alternative set after the increase in the print line number, the size setting section does not preferably change the size of the character image after the increase in the print line number from the size of the character image set before the increase in the print line number.

According to the configuration, a size of a character image is not changed before and after an increase in a print line number when the size of the character image before the increase in the print line number does not exceed a maximum alternative set after the increase in the print line number.

In this case, the information processing device preferably further includes: the size setting section that sets the size of the character image. When the print line number is increased and then restored to the print line number before being increased, the size setting section preferably sets the size of the character image after the restoration of the print line number at the size of the character image set before the increase in the print line number.

According to the configuration, a point size of a character image is automatically set at the same size as that before an increase in a print line number when the print line number is increased and then restored to the print line number before being increased.

### BRIEF DESCRIPTION OF THE DRAWINGS

FIG. 1 is a diagram showing a mobile terminal and a printing system including the mobile terminal according to an embodiment of the present invention.

FIG. 2 is a block diagram of the mobile terminal and a tape printing apparatus.

FIG. 3 is a block diagram showing the function configurations of a terminal-side control unit.

FIG. 4 is a flowchart showing arithmetic processing for setting a maximum alternative by an alternative setting section.

FIGS. 5A to 5D are diagrams for describing the setting of the size of a character image in the mobile terminal.

FIGS. 6A to 6D are diagrams for describing the setting of the size of the character image in the mobile terminal when a tape width is different from that of FIGS. 5A to 5D.

FIG. 7 is a diagram for describing the setting of the size of the character image in the mobile terminal when a direction of the character image is changed from a horizontal writing direction to a vertical writing direction.

FIGS. 8A to 8C are diagrams for describing the setting of the size of the character image in the mobile terminal when a print line number is changed.

FIGS. 9A to 9C are diagrams for describing the setting of the size of the character image in the mobile terminal when the print line number is changed like the case of FIGS. 8A to 8C.

FIGS. 10A to 10D are diagrams for describing the setting of the size of the character image in a mobile terminal according to a comparative example.

### BEST MODES FOR CARRYING OUT THE INVENTION

Hereinafter, a description will be given, with reference to the accompanying drawings, of a mobile terminal 1 and a printing system P including the mobile terminal 1 according to an embodiment of the information processing device of the present invention.

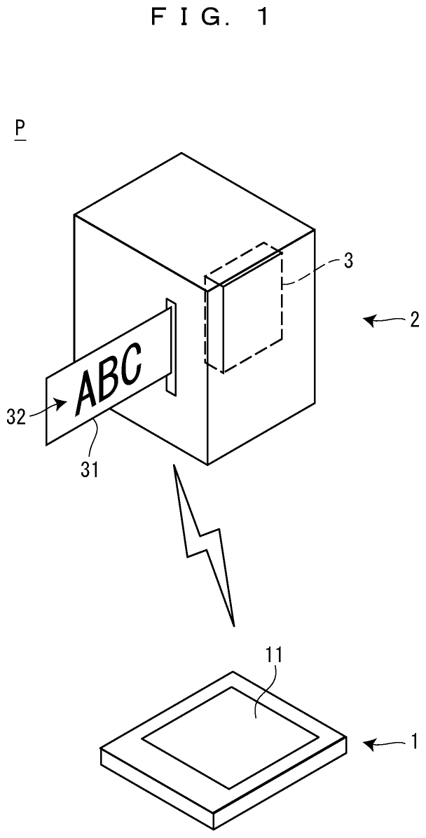

A description will be given, with reference to FIG. 1, of the outline of the printing system P. The printing system P includes the mobile terminal 1 and a tape printing apparatus 2. The mobile terminal 1 and the tape printing apparatus 2 are wirelessly connected so as to be capable of communicating with each other. Note that the tape printing apparatus 2 functions as an access point for the mobile terminal 1.

As the mobile terminal 1, a smartphone, a tablet terminal, or the like can be, for example, used. In the mobile terminal 1, an application program (hereinafter called a “corresponding application”) corresponding to the tape printing apparatus 2 is installed. The mobile terminal 1 functions as an information processing device that controls the tape printing apparatus 2 by activating the corresponding application. Note that the corresponding application is downloaded or installed in the mobile terminal 1 from, for example, a prescribed web site. In addition, the mobile terminal 1 includes a touch panel 11. The touch panel 11 functions as a user interface.

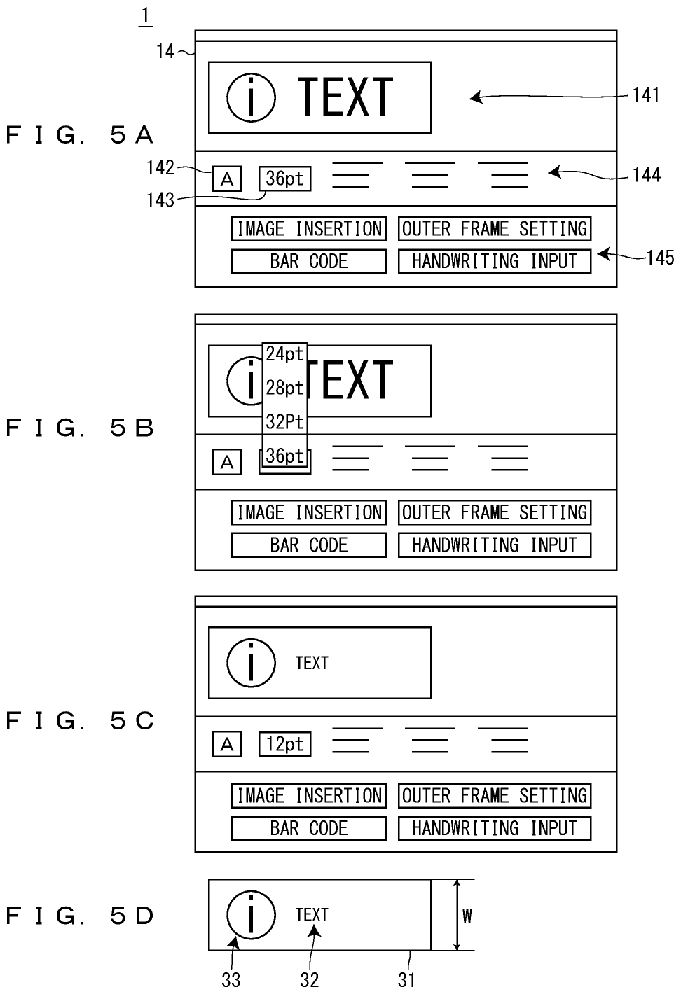

A tape cartridge 3 is attachably and detachably installed in the tape printing apparatus 2. Based on print data received from the mobile terminal 1, the tape printing apparatus 2 prints a character image 32 on a tape 31 drawn from the tape cartridge 3. Note that the character image 32 represents an image of characters such as texts, symbols, and emoji (pictorial symbols). As the tape cartridge 3, a plurality of types different in a width dimension (hereinafter called a “tape width W” as seen in FIG. 5(D)) of the tape 31 is provided. The contour of the tape cartridge 3 is different according to the tape width W.

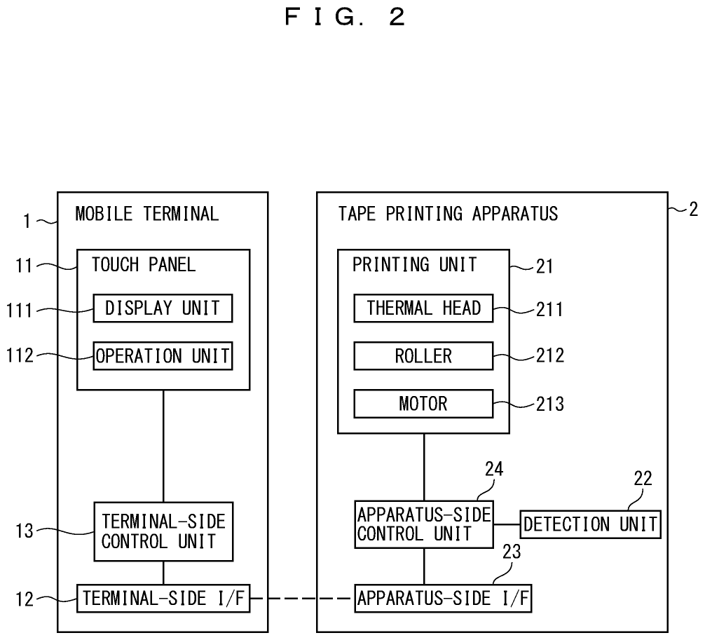

A description will be given, with reference to FIG. 2, of the mobile terminal 1 and the tape printing apparatus 2. The mobile terminal 1 includes a display unit 111, an operation unit 112, a terminal-side interface 12 (terminal-side I/F), and a terminal-side control unit 13.

The display unit 111 and the operation unit 112 constitute the above touch panel 11. The display unit 111 displays various screens. The operation unit 112 detects a touch operation by a user on the touch panel 11 and outputs a detection result to the terminal-side control unit 13.

The terminal-side interface 12 performs wireless communication with the tape printing apparatus 2. The terminal-side interface 12 sends and receives various commands and various data to and from an apparatus-side interface 23 that will be described later.

The terminal-side control unit 13 controls the respective units of the mobile terminal 1. The terminal-side control unit 13 includes a CPU (Central Processing Unit), a ROM (Read Only Memory), and a RAM (Random Access Memory). The CPU performs various processing by running various programs stored in the ROM and containing the above corresponding application with the RAM.

The tape printing apparatus 2 includes a printing unit 21, a detection unit 22, the apparatus-side interface (apparatus side I/F), and an apparatus-side control unit 24.

The printing unit 21 prints the character image 32 on the tape 31. The printing unit 21 includes a thermal head 211, a roller 212, and a motor 213. The thermal head 211 is driven to generate heat based on print data received from the mobile terminal 1. The roller 212 draws the tape 31 from the tape cartridge 3 and feeds the same. The motor 213 serves as a driving source for the roller 212.

The detection unit 22 detects the tape width W of the tape 31 of the tape cartridge 3 installed in the tape printing apparatus 2. As the detection unit 22, a switch that changes its ON/OFF state depending on a difference in the contour of the tape cartridge 3 can be, for example, used.

The apparatus-side interface 23 performs wireless communication with the mobile terminal 1. The apparatus-side interface 23 sends and receives various commands and various data to and from the terminal-side interface 12.

The apparatus-side control unit 24 controls the respective units of the tape printing apparatus 2. The apparatus-side control unit 24 includes a CPU, a ROM, and a RAM. The CPU performs various processing by running various programs stored in the ROM with the RAM.

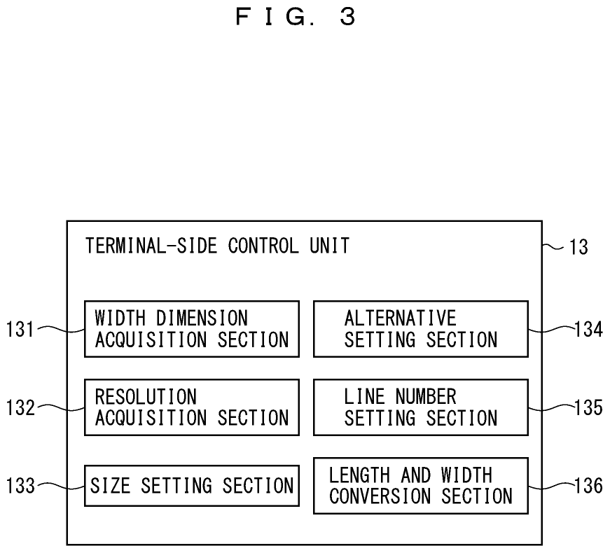

A description will be given, with reference to FIG. 3, of the function configurations of the terminal-side control unit 13. The terminal-side control unit 13 includes a width dimension acquisition section 131, a resolution acquisition section 132, a size setting section 133, an alternative setting section 134, a line number setting section 135, and a length and width conversion section 136. At least some of these function sections are realized by the cooperation between hardware constituting the terminal-side control unit 13 and software such as the corresponding application stored in the ROM.

The width dimension acquisition section 131 acquires the tape width W of the tape 31 of the tape cartridge 3 installed in the tape printing apparatus 2. The width dimension acquisition section 131 acquires the tape width W by making an inquiry at the tape printing apparatus 2 about the tape width W and then receiving the tape width W detected by the detection unit 22 from the tape printing apparatus 2. In addition, the width dimension acquisition section 131 may acquire the tape width W based on an input operation on the tape width W received by the operation unit 112.

The resolution acquisition section 132 acquires resolution (hereinafter called “printer resolution”) of the thermal head 211 of the tape printing apparatus 2. The resolution acquisition section 132 acquires the printer resolution by making an inquiry at the tape printing apparatus 2 about the printer resolution and then receiving a response for the inquiry. Note that the resolution acquisition section 132 may acquire the printer resolution by referring to a table in which the printer resolution and model information are associated with each other and then extracting the printer resolution with previously-acquired model information as a key.

The alternative setting section 134 sets a maximum alternative as a selectable alternative having a maximum size among a plurality of alternatives for selecting a point size representing a size of the character image 32. The alternative setting section 134 sets the maximum alternative so that the character image 32 to be printed on the tape 31 does not protrude from the tape 31 in the width direction of the tape 31. Arithmetic processing for setting the maximum alternative by the alternative setting section 134 will be described later.

The line number setting section 135 sets a print line number in the width direction of the tape 31. The line number setting section 135 sets the print line number based on the reception of a “line feed” or “delete” operation by the operation unit 112.

The size setting section 133 sets a size, i.e., a point size of the character image 32. When a maximum alternative that will be described later is newly set, the size setting section 133 sets the maximum alternative as the point size of the character image 32. In addition, the size setting section 133 sets an alternative selected by a user among a plurality of alternatives for selecting the point size as the point size. Moreover, as will be described in detail later, the size setting section 133 sets the point size according to a change in a print line number.

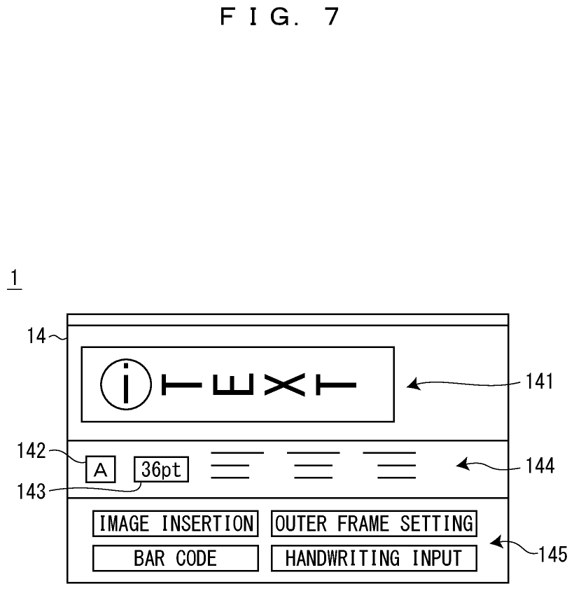

The length and width conversion section 136 changes a direction of the character image 32 to be printed on the tape 31 between a horizontal writing direction and a vertical writing direction based on the reception of a prescribed touch operation by the operation unit 112. Here, the horizontal writing direction represents a direction in which the vertical direction of the character image 32 is parallel to the width direction of the tape 31 (see FIGS. 5A to 5D). The vertical writing direction represents a direction in which the vertical direction of the character image 32 is parallel to the length direction of the tape 31 (see FIG. 7).

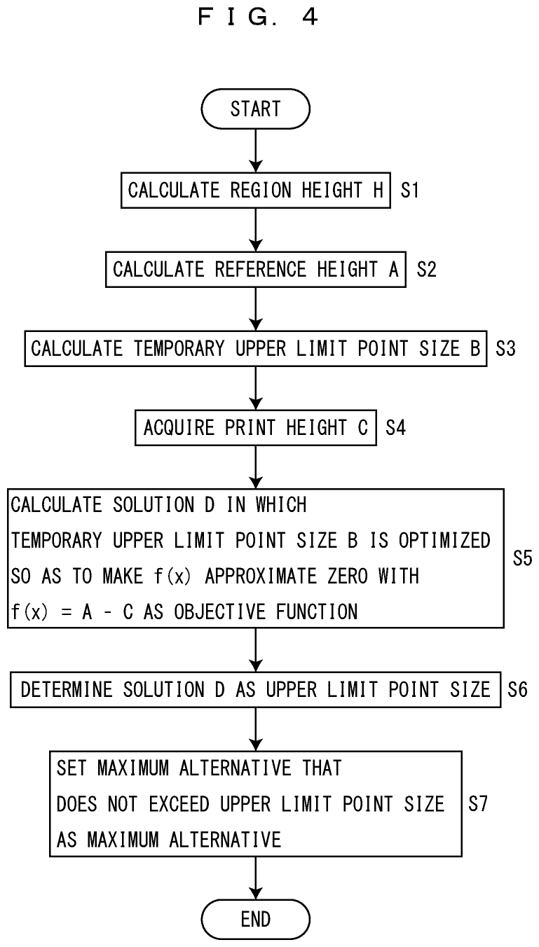

A description will be given, with reference to FIG. 4, of the arithmetic processing for setting a maximum alternative by the alternative setting section 134. In step S1, the alternative setting section 134 calculates a dot number (hereinafter called a “region height H”) of a printing region in the width direction of the tape 31 based on the tape width W and printer resolution. For example, when the tape width W is 24 mm and the printer resolution is 360 dpi, the alternative setting section 134 calculates the region height H as (24/25.4)×360=340 [dot]. Note that the whole tape width W is assumed as the printing region here, but a region smaller than the tape width W by a prescribed dimension may be assumed as the printing region.

The alternative setting section 134 proceeds to step S2 and divides the calculated region height H by a print line number to calculate a dot number (hereinafter called a “reference height A”) per line of the printing region in the width direction of the tape 31. For example, when the print line number is two, the alternative setting section 134 calculates the reference height A as 340/2=170 [dot].

The alternative setting section 134 proceeds to step S3 and calculates a point size (hereinafter called a “temporary upper limit point size B”) falling within the calculated reference height A. For example, when the point size is expressed as a DTP point (72 pt=1 inch), the alternative setting section 134 calculates the temporary upper limit point size B as 170×(72/360)=34 [pt].

The alternative setting section 134 proceeds to step S4 and acquires a dot number (hereinafter called a “print height C”) of the character image 32 in the width direction of the tape 31 when the character image 32 is drawn at the temporary upper limit point size in the horizontal writing direction by OS. The alternative setting section 134 refers to font size data set for each font and acquires the print height C based on the calculated temporary upper limit point size B and a selected font. The font size data represents data in which a point size and a vertical dimension of the character image 32 in the horizontal writing direction are associated with each other for each font, and is stored in the ROM of the terminal-side control unit 13. As described above, the print height C is calculated based on the font size data set for each front. Therefore, the print height C can be appropriately calculated even when a vertical dimension of the character image 32 is different depending on a font.

The alternative setting section 134 proceeds to step S5 and calculates a solution D in which the temporary upper limit point size B is optimized so as to make f(x) approximate zero with f(x) given in the following formula as an objective function.

f(x)=A−C

A: Reference height

C: Print height

The alternative setting section 134 proceeds to step S6 and determines the calculated solution D as an upper limit point size. The upper limit point size determined as described above represents an upper limit size of the character image 32 at which the character image 32 does not protrude from the tape 31 in the width direction of the tape 31.

The alternative setting section 134 proceeds to step S7 and sets a maximum alternative that does not exceed the determined upper limit point size among the alternatives of point sizes as a maximum alternative. For example, when the eight alternatives of 8 pt, 12 pt, 16 pt, 20 pt, 24 pt, 28 pt, 32 pt, and 36 pt in total are provided as the point sizes and 34 pt is determined as the upper limit point size, the alternative setting section 134 selects 32 pt as the maximum alternative. After setting the maximum alternative as described above, the alternative setting section 134 ends a series of the processing.

Note that even in a case in which the character image 32 is set to be oriented in the vertical writing direction, the alternative setting section 134 acquires the print height C representing a dot number when the character image 32 is drawn in the horizontal writing direction by the OS based on the font size data in which the point sizes and the vertical dimensions of the character image 32 in the horizontal writing direction are associated with each other. Accordingly, a maximum alternative determined based on the print height C is not changed with a change in the direction of the character image 32 between the horizontal writing direction and the vertical writing direction.

A description will be given, with reference to FIGS. 5A to 5D to FIGS. 9A to 9C, of the setting of the size of the character image 32 in the mobile terminal 1.

FIG. 5A shows an edit screen 14 displayed on the touch panel 11. On the edit screen 14, a preview image 141, a character setting section 142, a point selection section 143, an arrangement position selection section 144, and an input section 145 are displayed.

The preview image 141 is a preview of the tape 31 in which the character image 32 is drawn for printing based on text data representing the character image 32 and the tape width W. The text data is input from, for example, a software keyboard (not shown) displayed on the edit screen 14. Here, half-size characters are input as the text data. In addition, one line is set as a print line number.

The character setting section 142 is used to display a separate screen for setting a font and a direction of the character image 32 on the touch panel 11. Here, the character image 32 is set to be oriented in the horizontal writing direction. Note that when the font and the direction of the character image 32 are set, a picker may be displayed in a lower column or the font and the character may be selected from a message box besides displaying the separate screen.

In the point selection section 143, a point size of the character image 32 set by the size setting section 133 is displayed. Here, 18 mm is acquired as the tape width W, and a maximum alternative is set at 36 pt by the alternative setting section 134. Thus, the size setting section 133 sets the point size of the character image 32 at 36 pt. As a result, “36 pt” is displayed in the point selection section 143, and the preview of the character image 32 is displayed at 36 pt as the preview image 141.

The arrangement position selection section 144 is used to set any of left justification, centering, and right justification as an arrangement position of the character image 32 in the length direction of the tape 31 based on a touch operation for the arrangement position selection section 144. The input section 145 is used to input an image such as a symbol mark 33, a bar code, an outer frame, and a handwriting character besides the character image 32.

When the point selection section 143 is touched, the display unit 111 displays a plurality of point sizes so that the above maximum alternative set by the alternative setting section 134 becomes a maximum point size. In other words, the display unit 111 does not display point sizes exceeding the maximum alternative. Here, since the maximum alternative is set at 36 pt, the display unit 111 displays the plurality of point sizes so that 36 pt becomes the maximum point size (see FIG. 5B). Note that although FIG. 5B shows the four alternatives of 24 pt, 28 pt, 32 pt, and 36 pt, it is possible to display other alternatives not exceeding 36 pt by vertically dragging the alternatives.

When 12 pt is, for example, selected from among the plurality of selectable point sizes, the size setting section 133 sets the point size of the character image 32 at 12 pt. As a result, “12 pt” is displayed in the point selection section 143, and the preview of the character image 32 is displayed at 12 pt as the preview image 141.

Then, when the mobile terminal 1 receives a prescribed operation to perform printing, the tape printing apparatus 2 prints the 12-pt character image 32 on the tape 31 (see FIG. 5D).

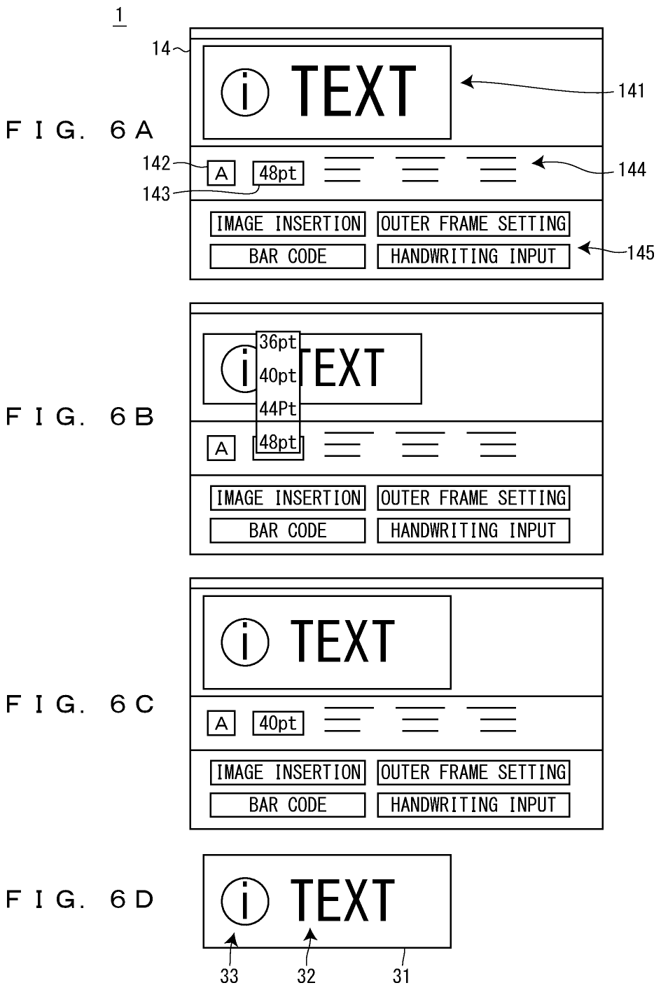

FIG. 6A shows a state in which the acquired tape width W has been changed to 24 mm from the state shown in FIG. 5A. Here, the maximum alternative is set at 48 pt by the alternative setting section 134 as the tape width W has been changed to 24 mm. Thus, the size setting section 133 sets the point size of the character image 32 at 48 pt. As a result, 48 pt is displayed in the point selection section 143, and the preview of the character image 32 is displayed at 48 pt as the preview image 141.

When the point selection section 143 is touched, the display unit 111 displays a plurality of point sizes so that 48 pt becomes a maximum point size since the maximum alternative has been set at 48 pt (see FIG. 6B).

When 40 pt is, for example, selected from among the plurality of selectable point sizes, the size setting section 133 sets the point size of the character image 32 at 40 pt. As a result, “40 pt” is displayed in the point selection section 143, and the preview of the character image 32 is displayed at 40 pt as the preview image 141 (see FIG. 6C).

Then, when the mobile terminal 1 receives the prescribed operation to perform printing, the tape printing apparatus 2 prints the 40-pt character image 32 on the tape 31 (see FIG. 6D).

FIG. 7 shows a state in which the direction of the character image 32 has been changed to the vertical writing direction by the length and width conversion section 136 from the state shown in FIG. 5A. Here, as described above, the maximum alternative is not changed even with a change in the direction of the character image 32 between the vertical writing direction and the horizontal writing direction. Therefore, the point size of the character image 32 is not changed by the size setting section 133 and remains at 36 pt representing the point size before the direction of the character image 32 has been changed to the vertical writing direction. As a result, 36 pt is displayed in the point selection section 143, and the preview of the character image 32 is displayed at 36 pt as the preview image 141.

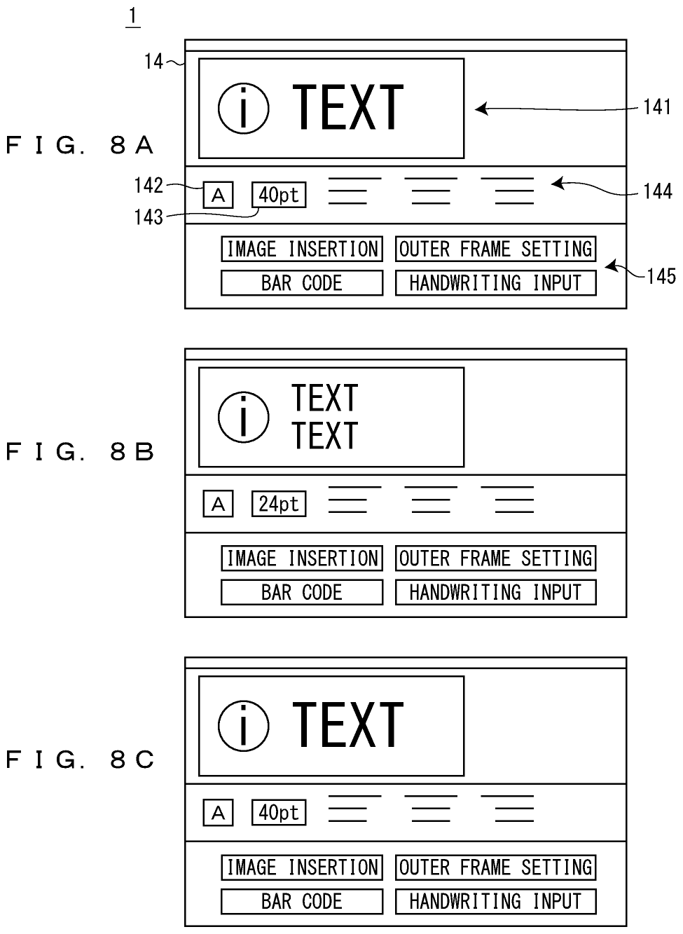

FIG. 8A shows the same state as that of FIG. 6C. When a “line feed” operation is performed from this state to input the character image 32 in the second line as shown in FIG. 8B, the maximum alternative is set at, for example, 24 pt by the alternative setting section 134 as a print line number is increased from one to two. Here, the point size (40 pt) set before the print line number is increased to two exceeds the maximum alternative (24 pt) set after the print line number is increased to two. Therefore, the size setting section 133 sets the maximum alternative (24 pt) set after the print line number is increased as the point size of the character image 32 after the increase in the print line number. Thus, 24 pt is displayed in the point selection section 143. In addition, the preview of the character image 32 in each line is displayed at 24 pt as the preview image 141. Note that the size setting section 133 may set the point size of the character image 32 after the increase in the print line number at a point size smaller than the maximum alternative (24 pt) set after the increase in the print line number, for example, 20 pt.

FIG. 8C shows a state in which a “delete” operation has been performed from the state shown in FIG. 8B to delete the second line. In this case, the maximum alternative is set at 48 pt by the alternative setting section 134 as the print line number is restored to one. Here, the size setting section 133 does not set the point size of the character image 32 at the maximum alternative (48 pt) but sets the same at the point size (40 pt) set before the print line number is increased to two. Thus, 40 pt is displayed in the point selection section 143. In addition, the preview of the character image 32 is displayed at 40 pt as the preview image 141.

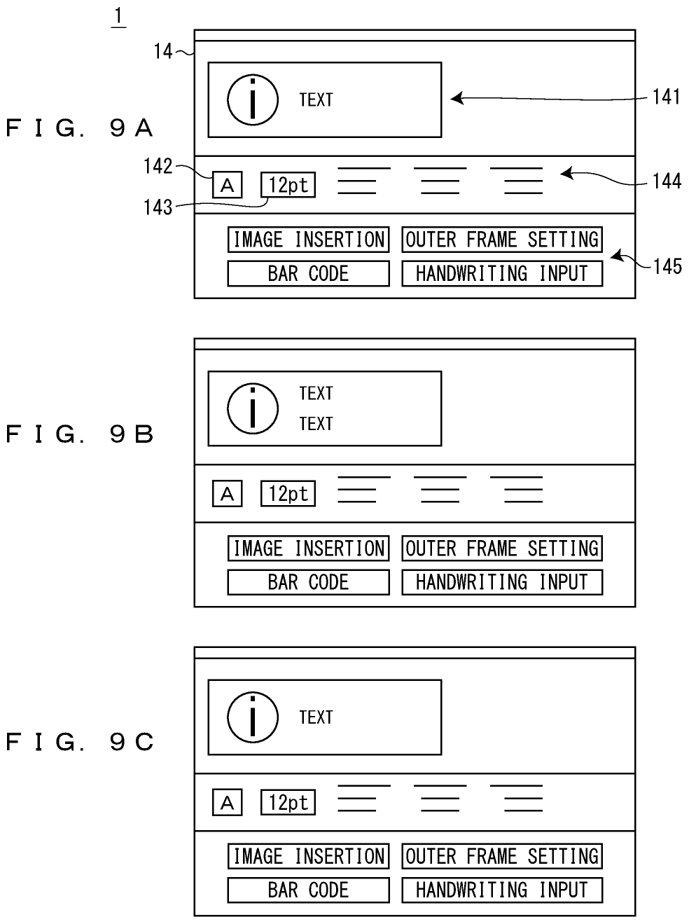

FIG. 9A shows the same state as that of FIG. 5C. When a “line feed” operation is performed from this state to input the character image 32 in the second line as shown in FIG. 9B, the maximum alternative is set at 18 pt by the alternative setting section 134 as a print line number is increased from one to two. Here, the point size (12 pt) set before the print line number is increased to two does not exceed the maximum alternative (18 pt) set after the print line number is increased to two. Therefore, the size setting section 133 does not set the point size of the character image 32 after the increase in the print line number at the maximum alternative (18 pt) but sets the same at the point size (12 pt) set before the print line number is increased. Thus, 12 pt is displayed in the point selection section 143. In addition, the preview of the character image 32 in each line is displayed at 12 pt as the preview image.

FIG. 9C shows a state in which a “delete” operation has been performed from the state shown in FIG. 9B to delete the second line. In this case, the maximum alternative is set at 36 pt by the alternative setting section 134 as the print line number is restored to one. Here, the size setting section 133 does not set the point size of the character image 32 at the maximum alternative (36 pt) but sets the same at the point size (12 pt) set before the print line number is increased to two. Thus, 12 pt is displayed in the point selection section 143. In addition, the preview of the character image 32 is displayed at 12 pt as the preview image 141.

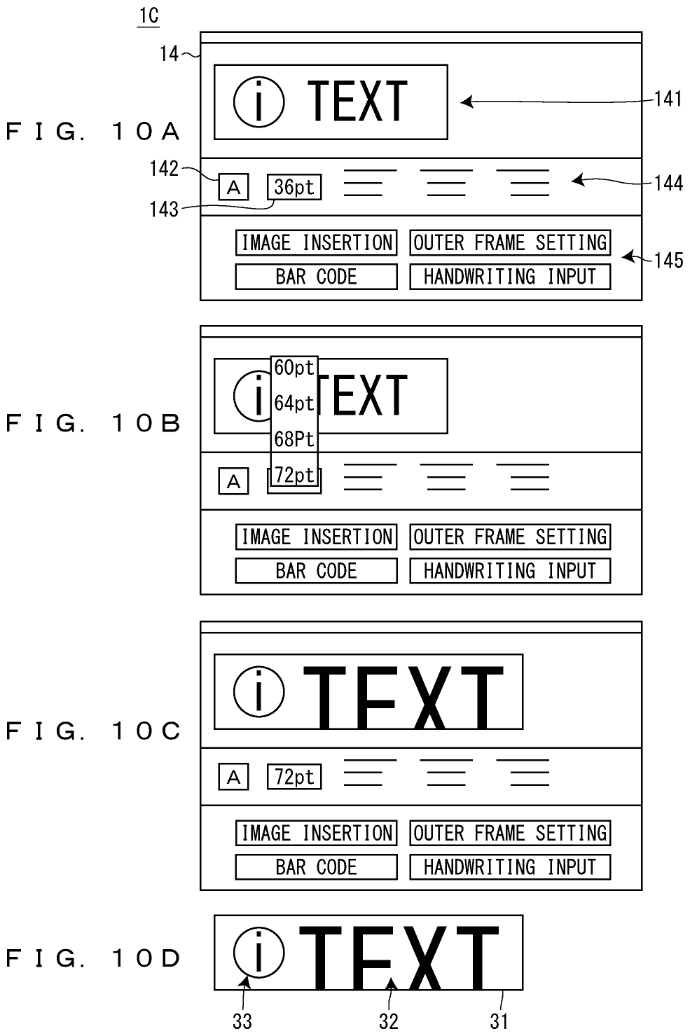

A description will be given, with reference to FIGS. 10A to 10D, of the setting of the size of the character image 32 in a mobile terminal (hereinafter called a “mobile terminal 1C”) according to a comparative example. Although including the substantially same configurations as those of the mobile terminal 1 of the embodiment, the mobile terminal 1C is different in that the mobile terminal 1C does not include the alternative setting section 134.

FIG. 10A shows the edit screen 14 displayed on the mobile terminal 1C. Here, the acquired tape width W is 18 mm, and a point size of the character image 32 is set at 36 pt by the size setting section 133. As a result, 36 pt is displayed in the point selection section 143, and a preview of the character image 32 is displayed at 36 pt as the preview image 141.

When the point selection section 143 is touched, point sizes at which the character image 32 is printed in a state of protruding from the tape 31 having the tape width W of 18 mm, i.e., a plurality of point sizes containing point sizes exceeding 36 pt are displayed so as to be selectable (see FIG. 10B).

When 72 pt is, for example, selected from among the plurality of selectable point sizes, the size setting section 133 sets the point size of the character image 32 at 72 pt. As a result, “72 pt” is displayed in the point selection section 143, and the preview of the 72-pt character image 32 is displayed in a state of protruding from the tape 31 in the width direction of the tape 31 as the preview image 141 (see FIG. 10C).

Then, when the mobile terminal 1 receives a prescribed operation to perform printing, the tape printing apparatus 2 prints the 72-pt character image 32 in a state of protruding from the tape 31 in the width direction of the tape 31 (see FIG. 10D).

As described above, the mobile terminal 1 of the embodiment includes the width dimension acquisition section 131 and the alternative setting section 134. The width dimension acquisition section 131 acquires the tape width W of the tape 31 on which the character image 32 is to be printed. The alternative setting section 134 sets a maximum alternative among a plurality of alternatives for selecting a point size of the character image 32 according to the acquired tape width W so that the character image 32 does not protrude from the tape 31.

According to the configuration, the character image 32 is printed so as not to protrude from the tape 31 even when a maximum alternative is selected. Thus, according to the configuration, a user is allowed to select a point size of the character image 32 within a range in which the character image 32 does not protrude from the tape 31.

In the mobile terminal 1 of the embodiment, the alternative setting section 134 determines an upper limit point size representing an upper limit size of the character image 32 at which the character image 32 does not protrude from the tape 31 based on the acquired tape width W. In addition, the alternative setting section 134 sets a maximum alternative that does not exceed a determined upper limit point size among a plurality of alternatives as a maximum alternative.

According to the configuration, an alternative closer to an upper limit point size of the character image 32 is set as a maximum alternative. Thus, according to the configuration, a maximum alternative within a range in which the character image 32 does not protrude from the tape 31 can be set as a maximum alternative.

The mobile terminal 1 of the embodiment includes the length and width conversion section 136 that changes a direction of the character image 32 to be printed on the tape 31 between the horizontal writing direction and the vertical writing direction. The alternative setting section 134 sets a maximum alternative based on font size data in which vertical dimensions and point sizes of the character image 32 in the horizontal writing direction are associated with each other in both a case in which the character image 32 is oriented in the horizontal writing direction and a case in which the character image 32 is oriented in the vertical writing direction.

According to the configuration, a change in a maximum alternative is prevented when a direction of the character image 32 is changed between the horizontal writing direction and the vertical writing direction. Therefore, a change in a point size of the character image 32 as a maximum alternative is changed is also prevented. That is, when it is desired that only a direction of the character image 32 be changed without a change in a point size of the character image 32, the change in the point size against a user's intension is prevented.

The mobile terminal 1 of the embodiment includes the size setting section 133 that sets a point size of the character image 32. When a point size of the character image 32 set before an increase in a print line number exceeds a maximum alternative set after the increase in the print line number, the size setting section 133 sets a point size of the character image 32 after the increase in the print line number at the maximum alternative set after the increase in the print line number.

According to the configuration, when a point size of the character image 32 set before an increase in a print line number exceeds a maximum alternative set after the increase in the print line number, a point size of the character image 32 after the increase in the print line number is automatically set so that the character image 32 does not protrude from the tape 31.

In the mobile terminal 1 of the embodiment, when a point size of the character image 32 set before an increase in a print line number does not exceed a maximum alternative set after the increase in the print line number, the size setting section 133 does not change a point size of the character image 32 after the increase in the print line number from the point size of the character image 32 set before the increase in the print line number.

According to the configuration, a point size of the character image 32 is not changed before and after an increase in a print line number when the point size of the character image 32 set before the increase in the print line number does not exceed a maximum alternative set after the increase in the print line number.

In the mobile terminal 1 of the embodiment, when a print line number is increased and then restored to the print line number before being increased, the size setting section 133 sets a point size of the character image 32 after the restoration of the print line number at a point size of the character image 32 set before the increase in the print line number.

According to the configuration, a point size of the character image 32 is automatically set at the same point size as that before an increase in a print line number when the print line number is increased and then restored to the print line number before being increased.

The present invention is not limited to the above embodiment and may employ various configurations without departing from its sprit as a matter of course. For example, the embodiment can be modified into the following modes.

A corresponding application may be stored in a recording medium such as a CD-ROM (Compact Disc Read Only Memory) and a flash memory to be provided.

The mobile terminal 1 may be communicably connected to the tape printing apparatus 2 via an access point other than the tape printing apparatus 2, for example, a wireless LAN (Local Area Network) router. In addition, the mobile terminal 1 may be communicably connected to the tape printing apparatus 2 via, for example, a USB (Universal Serial Bus) cable.

The mobile terminal 1 may be replaced by a general-purpose computer.

Moreover, the tape printing apparatus 2 may include the above width dimension acquisition section 131, the alternative setting section 134, or the like. In this case, the tape printing apparatus 2 is capable of functioning as the information processing device of the present invention.

### EXPLANATION OF REFERENCE SYMBOLS

1: mobile terminal
31: tape
32: character image
131: width dimension acquisition section
134: alternative setting section
W: tape width

1. An information processing device comprising:
a width dimension acquisition section that acquires a width dimension of a tape on which a character image is to be printed; and
an alternative setting section that sets a maximum alternative, which represents a selectable alternative having a maximum size among a plurality of alternatives for selecting a size of the character image, according to the acquired width dimension so that the character image does not protrude from the tape.

2. The information processing device according to claim 1, wherein
the alternative setting section determines an upper limit size of the character image, at which the character image does not protrude from the tape, based on the acquired width dimension, and
the alternative setting section sets an alternative having a maximum size that does not exceed the determined upper limit size among the plurality of alternatives as the maximum alternative.

3. The information processing device according to claim 1, further comprising:
a length and width conversion section that changes a direction of the character image that is to be printed on the tape between a horizontal writing direction in which a vertical direction of the character image is parallel to a width direction of the tape and a vertical writing direction in which the vertical direction of the character image is parallel to a length direction of the tape, wherein
the alternative setting section sets the maximum alternative based on a vertical dimension of the character image in the horizontal writing direction in both a case in which the character image is oriented in the horizontal writing direction and a case in which the character image is oriented in the vertical writing direction.

4. The information processing device according to claim 1, further comprising:
a line number setting section that sets a print line number in the width direction of the tape, wherein
the alternative setting section sets the maximum alternative based on the set print line number.

5. The information processing device according to claim 4, further comprising:
a size setting section that sets the size of the character image, wherein,
when the size of the character image set before an increase in the print line number exceeds the maximum alternative set after the increase in the print line number, the size setting section sets the size of the character image after the increase in the print line number so as not to exceed the maximum alternative set after the increase in the print line number.

6. The information processing device according to claim 5, wherein,
when the size of the character image set before the increase in the print line number does not exceed the maximum alternative set after the increase in the print line number, the size setting section does not change the size of the character image after the increase in the print line number from the size of the character image set before the increase in the print line number.

7. The information processing device according to claim 4, further comprising:
the size setting section that sets the size of the character image, wherein,
when the print line number is increased and then restored to the print line number before being increased, the size setting section sets the size of the character image after the restoration of the print line number at the size of the character image set before the increase in the print line number.

8. An alternative setting method of an information processing device, the alternative setting method performing:
a step of acquiring a width dimension of a tape on which a character image is to be printed; and
a step of changing a selectable alternative having a maximum size among a plurality of alternatives for selecting a size of the character image according to the acquired width dimension so that the character image does not protrude from the tape.

9. A program that causes a computer to function as the respective sections of the information processing device according to claim 1.

10. The information processing device according to claim 5, further comprising:
the size setting section that sets the size of the character image, wherein,
when the print line number is increased and then restored to the print line number before being increased, the size setting section sets the size of the character image after the restoration of the print line number at the size of the character image set before the increase in the print line number.

11. The information processing device according to claim 6, further comprising:
the size setting section that sets the size of the character image, wherein,
when the print line number is increased and then restored to the print line number before being increased, the size setting section sets the size of the character image after the restoration of the print line number at the size of the character image set before the increase in the print line number.
